(19) United States
(12) Patent Application Publication
(10) Pub. No.: US 2009/0042066 A1
(43) Pub. Date: Feb. 12, 2009

(54) Adjustable Barrier For Regulating Flow Of A Fluid

(75) Inventors: Steve Simon, Middletown, NJ (US); Victor A. Lifton, Bridgewater, NJ (US); Nathalie Pereira, North Brunswick, NJ (US); Glenn G. Amatucci, Peapack, NJ (US)

Correspondence Address: FISH & RICHARDSON P.C., P.O. BOX 1022, MINNEAPOLIS, MN, 55440-1022, US

(73) Assignee: MPHASE TECHNOLOGIES, INC., Little Falls, NJ (US)

(21) Appl. No.: 11/837,405

(22) Filed: Aug. 10, 2007

(51) Int. Cl. H01M 6/30

(52) U.S. Cl. 429/10; 429/118; 429/52

(57) ABSTRACT

An electrochemical cell includes a first cell, a second cell and a barrier isolating a fluid in the first cell from the second cell in which the barrier, in response to an activation signal, changes to a second state to allow the fluid to pass into the second cell and activate the electrochemical cell.

### BACKGROUND

This disclosure relates to adjustable barriers for regulating flow of a fluid.

Reserve batteries are special purpose primary batteries having electrodes in a cell that is separate from a liquid electrolyte in which the electrodes are intended to react. While separated, no electricity is generated by the battery. However, volatile chemical vapors, evaporation or condensation from the electrolyte liquid may contaminate the system over time. Introducing the electrolyte solution into the inactive cell area such that the electrolyte and electrodes interact to produce a potential difference across the electrodes constitutes an activated (triggered) working battery.

### SUMMARY

The details of one or more embodiments of the invention are set forth in the description below, the accompanying drawings and in the claims.

For example, in one aspect, an electrochemical cell includes a first cell, a second cell and an adjustable barrier in which the barrier, in a first state, isolates a fluid in the first cell from the second cell and in which the barrier, in response to an activation signal, changes to a second state to allow the fluid to pass into the second cell and activate the electrochemical cell.

In another aspect, a method for activating an electrochemical cell that includes a first cell and a second cell includes rotating a barrier about an axis to a first position to block flow of a fluid from the first cell to the second cell and rotating the barrier to a second position to allow the fluid to flow from the first cell to the second cell to interact with an element in the second cell to activate the electrochemical cell.

In yet another aspect, a method for activating the electrochemical cell includes providing a first member having a through-hole that, in a first position, overlaps a second member having a through-hole such that the through-holes are misaligned and the first and second member block the flow of a fluid from the first cell to the second cell. Adjusting each of the first and second members to a second position in which a portion of the through-hole in the first member is at least partially aligned with a portion of the through-hole in the second member can allow fluid to flow from the first cell through the at least partially aligned through-holes into the second cell and interact with the element in the second cell to activate the electrochemical cell.

In another aspect, a method of activating the electrochemical cell includes providing the barrier, in a first position, to prevent the flow of fluid from the first cell to the second cell and deforming or removing the barrier to allow the fluid to flow from the first cell to the second cell to interact with the element in the second cell and activate the electrochemical cell.

Implementations include one or more of the following features. For example, the second cell can include one or more electrodes. In some cases, the fluid includes a solvent solution mixed with a salt.

In some examples, the fluid includes an electrolyte solution. The electrolyte solution may comprise ions to transport charge between a first electrode and a counter-electrode. Activation of the electrochemical cell includes, for example, an electrochemical reaction between the electrolyte solution and the one or more electrodes that produces an electric potential. Alternatively or in addition, activation includes ion transportation between the electrolyte solution and the one or more electrodes to produce an electric potential.

The activation signal can include an applied electrical current, electric field, magnetic field, electromagnetic field, or change in temperature.

In some implementations, the barrier includes a rotatable member. The barrier also can include a first member and a second member overlapping the first member in which a through-hole in the first member can be aligned with a through-hole in the second member, in response to the activation signal, such that a portion of the through-hole in the first member aligns with a portion of the through-hole in the second member. Each of the first and second members can include a non-wettable layer.

In some implementations, the barrier includes a material that deforms in response to a change in temperature, an applied electric potential, or an applied magnetic field. The material can be, for example, a piezoelectric material or nitinol.

In some cases, the barrier includes two materials having different thermal expansion coefficients. Additionally, the barrier can include two piezoelectric materials with alternate polarities.

In another example, the barrier includes a material that dissolves under an applied electric potential when in contact with the fluid of the first cell. The barrier material can include gold, copper or zinc whereas the fluid may include an electrolyte solution having chlorine ions.

In some instances, the barrier has a heater and a layer of material on the heater in which the layer of material melts upon activation of the heater. The material can include a polymer or wax.

In some implementations, the barrier includes a first member and a second member disposed on the first member in which the second member is configured to break in response to expansion or contraction of the first member so that an opening forms in the barrier. Alternatively, or in addition, the barrier includes a fluid disposed between the first and second member in which both the first and second member are configured to break in response to expansion or contraction of the fluid such that an opening forms in the barrier.

In another example, the barrier includes a flexible member. In some cases, the barrier has a non-wetting surface.

The barrier can include a stretchable member that has one or more openings extending from the first cell to the second cell in which the size of the opening, in a first state, prevents fluid from passing into the second cell and in which the size of the opening, in a second state, is stretched such that the fluid is allowed to pass into the second cell.

The cell can further include a plurality of second cells, in which the barrier isolates the fluid in the first cell from a plurality of second cells. The barrier can be activated to allow the fluid to pass into and activate one or more of the plurality of second cells.

In another aspect, the electrochemical cell includes a first cell, a second cell and a first and second adjustable barrier in which the first and second barrier, in a first state, isolate the fluid in the first cell from the second cell. In response to a first activation signal, the first barrier can change to a second state that allows the fluid to pass to the second barrier. In response to a second activation signal, the second barrier can change to a second state that allows the fluid to pass into the second cell and activate the electrochemical cell.

In another aspect, a battery includes a first compartment containing an electrolyte solution, a second compartment containing electrodes, an adjustable barrier which, in a first state, isolates the electrolyte solution in the first compartment from the second compartment, and a lead connected to the adjustable barrier in which the barrier, in response to an electrical signal applied to the lead, is operable to allow the electrolyte solution to enter into the second compartment such that an electro-chemical reaction between the electrolyte solution and the electrodes generates an electrical potential difference across the electrodes.

The battery can include a cover on the first compartment having openings coated with a non-wetting layer. In some implementations, the cover includes a one-way fluid valve. In some implementations, the battery also includes a re-sealable and pierceable cover.

### DESCRIPTION OF DRAWINGS

FIGS. 1A-1C illustrate an example of a reserve battery.

FIGS. 2A-2B illustrate an example of a reserve battery.

FIGS. 3A-3L illustrate examples of reserve batteries.

FIG. 4A illustrates an example of a reserve battery.

FIGS. 4B-4E are examples of fabrication steps for the reserve battery of FIG. 4A.

FIG. 5 illustrates an example of a reserve battery package.

FIG. 6 illustrates an example of a reserve battery package.

FIG. 7 illustrates an example of a reserve battery.

### DETAILED DESCRIPTION

An electrochemical cell is a device that converts chemical energy to electrical energy in the form of an electric potential or current. It includes one or more electrodes separated by a material that can transport charge between the electrodes. The material can be a fluid, such as an electrolyte solution, or solid. Examples of electrochemical cells include batteries and capacitors.

Controlled isolation of fluids in electrochemical cells can be difficult due to unwanted or inadvertent cross-contamination of the fluid, vapor or condensation into adjacent regions of the electrochemical cell. Although permeable barriers can prevent contamination into adjacent cells or regions, there is a risk that the membrane will not provide a sufficient barrier to protect the electrodes from reacting with electrolyte vapors or condensation.

This disclosure presents examples of adjustable barriers in the context of reserve micro-batteries. Reserve micro-batteries are batteries with sizes in the millimeter range or less that can be stored unused for long periods of time without losing charge. However, volatile chemical vapors, evaporation or condensation from the electrolyte liquid may contaminate the micro-battery over time. The adjustable barriers are used to separate a liquid electrolyte in one region of the battery from electrodes in a different region of the battery and to prevent premature exposure of the electrolyte to the electrodes. Because the adjustable barriers are formed as solid elements, unwanted chemical interactions between electrolyte vapors and the electrodes may be reduced. In addition, the solid barrier may limit leakage of the electrolyte solution into the region that includes the electrodes. By eliminating or reducing the potential for premature contamination or leakage, the effectiveness and longevity of the reserve battery can be substantially improved.

Upon activation of the reserve battery, the barrier can be removed or modified such that the liquid electrolyte is exposed to the electrodes and a subsequent interaction between the electrolyte and electrodes produces electricity. Activation of the battery occurs in response to a triggering event or activation signal that causes the barrier to be removed or modified and which occurs either within the battery itself or external to the device. The triggering event can be induced manually, occur automatically in response to a particular event, or occur after a particular threshold is reached. For example, a reserve battery may be activated when a voltage or capacity drop occurs in a primary battery of a system or device that was being monitored. The drop in voltage or capacity would induce the triggering event, such as a voltage or current signal, which would lead to activation of the reserve battery. Other events or conditions also can activate the reserve battery. These include, for example, conditions such as temperature, electrical and magnetic fields, vibration, pressure, acoustics, or the presence of chemical or biological agents.

However, the techniques described here are not limited to use in reserve micro-batteries and can be used, for example, in connection with other devices where separation of liquid and/or solid components is required. Other applications for which it is desirable to provide controlled isolation of liquids may be used as well. Those applications include, for example, controlled release of drugs or medication in the body or fluid storage in microfluidic devices, among others.

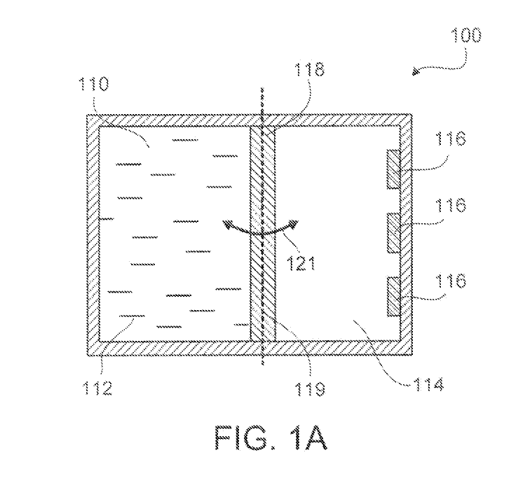

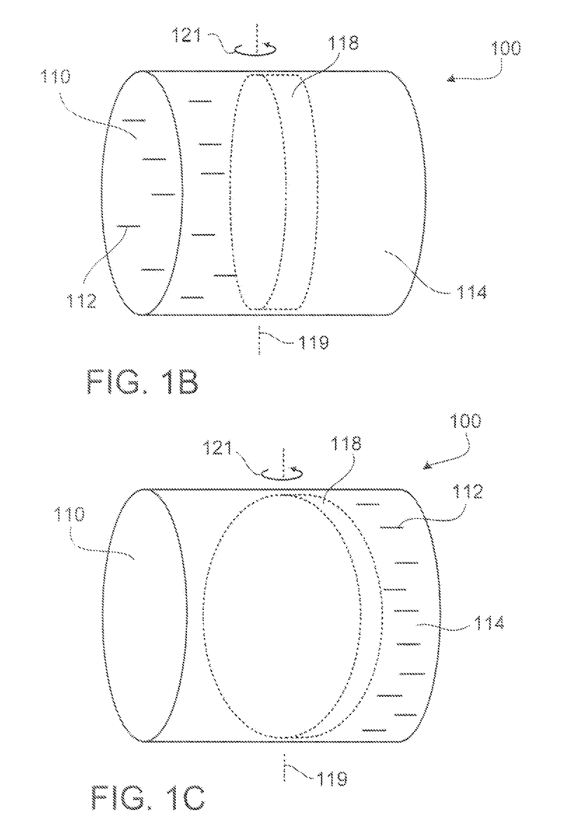

An example of a cross-section view of an adjustable barrier for a reserve battery 100 is illustrated in FIG. 1A. The battery includes a first region 110 containing an electrolyte solution 112, a second region 114 in which one or more thin film electrodes 116 are disposed, and a thin plate 118 that serves as an adjustable barrier between the first region 110 and second region 114. The regions 110, 114, electrodes 116, and thin plate 118 can be formed in or on a semiconductor substrate 120 using standard micro, nano, and micro-electro-mechanical systems (MEMS)-fabrication techniques. In some embodiments, the positioning or displacement of the adjustable barrier occurs automatically in response to an activation signal to allow the electrolyte solution in the first region to enter into the second region. Once in the second region, the electrolyte solution may electrochemically react with the electrodes, such as in an oxidation-reduction reaction, to produce a potential across the electrodes. Examples of the electrode material include Li, Zn/MnO₂, Li/MnO₂ and Li/BF3. The electrolyte solutions can include, for example, ternary and quaternary-carbonate based electrolytes containing linear esters (such as diethyl carbonate, ethylmethyl carbonate and ethyl acetate), aqueous solutions of ZnCl₂, or solutions of LiPF₆ in propylene carbonate. Other solutions and electrode pairs may be used as well. The role of the electrolyte may be directly involved in the participation in the electrochemical reaction between the electrodes and/or to transport charge between the electrodes without direct participation in the electrochemical reaction. In some cases, the fluid can includes a solvent solution mixed with a salt to accelerate an electro-chemical reaction between the electrodes and the fluid.

The plate 118 is located between the first region 110 and second region 114 and is secured at two ends to the substrate 120. Although secured to the substrate 120, the plate 118 can rotate about an axis 119, as shown by the arrows 121 in FIG. 1A, to control the flow of solution 112 from the first region 110 into the second region 114. In the example of FIG. 1A, the axis of rotation 119 of the plate 118 is arranged such that it is perpendicular to a direction of flow between the first region 110 and the second region 114. When the reserve battery is in an off-state, the plate 118 may be aligned with the cross-sectional opening between the first region 110 and second region 114 such that the electrolyte solution 112 is unable to pass into the second region 114. Upon activation of the reserve battery 100, the plate 118 is rotated to allow the electrolyte solution 112 to enter the second region 114 and react with electrodes 116. Alternate views of the reserve battery which illustrate the motion of the plate 118 are shown in FIGS. 1B and 1 C.

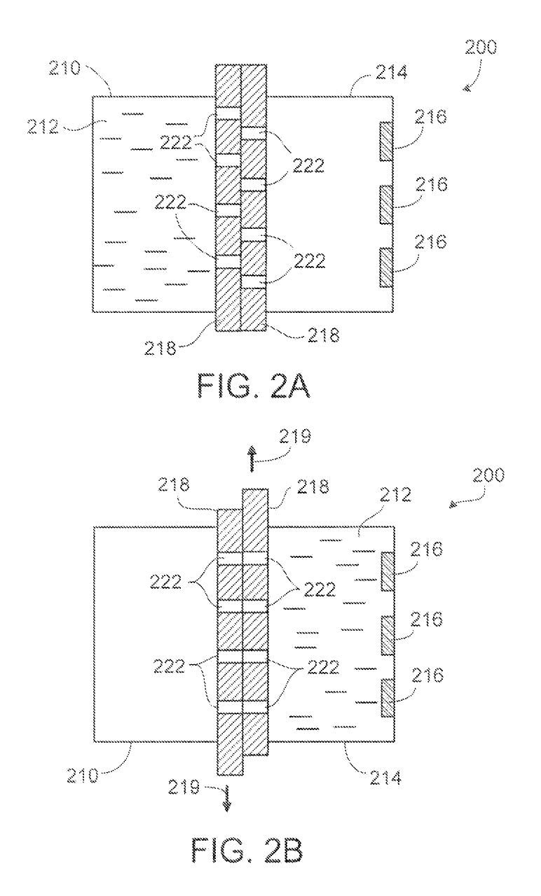

In some implementations, the barrier is fabricated as a series of plates 218 each of which includes through-holes or vias 222 as illustrated in the example cross-section of a reserve battery 200 shown in FIG. 2A. When the battery is inactive, the plates 218 are misaligned so that electrolyte solution 212 from the first region 210 cannot flow through the vias 222 into a second region 214 and make contact with electrodes 216. When the reserve battery 200 needs to be activated, the plates 218 are moved into a position such that the vias 222 align and the electrolyte solution 212 can flow from the first region 210 into the second region 214 as shown in FIG. 2B. The direction of plate motion is indicated by arrows 219. In another example, the plates 218 can be replaced with two concentric rotatable cylinders. Each cylinder can include through-holes that align depending on the rotation of each cylinder. When the through-holes are rotated into alignment, the electrolyte solution can flow from the first region to the second region.

To prevent accidental leakage of the solution 212 from the first region 210 into the second region 214 during the inactive state of the reserve battery, the surfaces 224 of the plates 218 or cylinders can be coated with a material that is not wetted by the electrolyte solution. Examples of non-wetting materials include hydrophobic polymers, oleophobic or hygrophobic monolayers as well as fluorinated polymers, such as Teflon. Other non-wetting materials also may be used. Alternatively, the surface can be patterned using nanofabrication techniques to form super hydrophobic nano-structured features. In addition, the non-wettable layers and materials are not limited to the plates 218 but can be used on or incorporated into any barrier provided at the interface of the first and second regions.

In some implementations, the adjustable barrier is formed using shape-memory materials. Shape-memory materials are materials that, once deformed, return to their original geometry after heating or, if they are at higher ambient temperatures, return to their original geometry simply by removing the load that caused deformation.

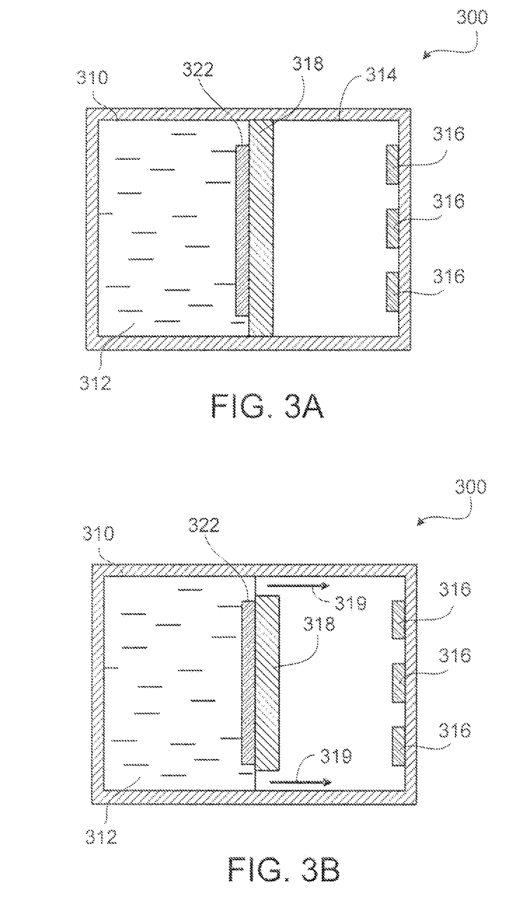

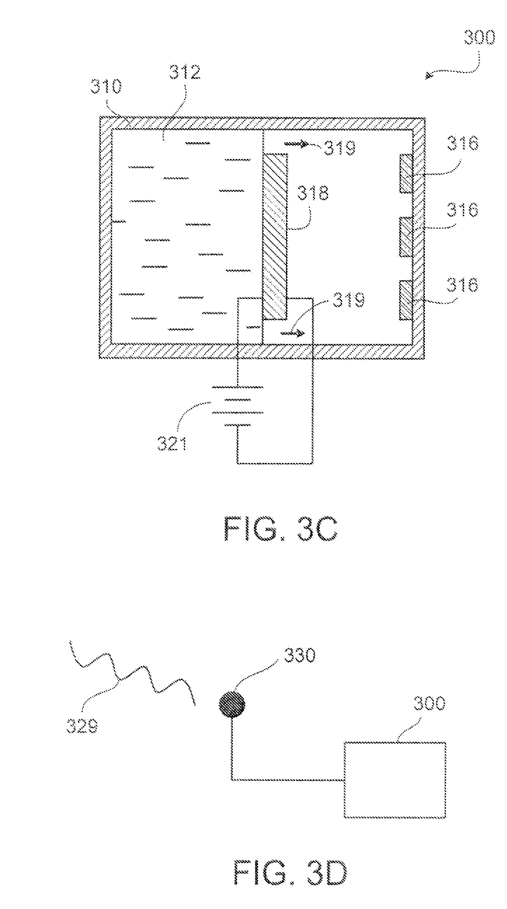

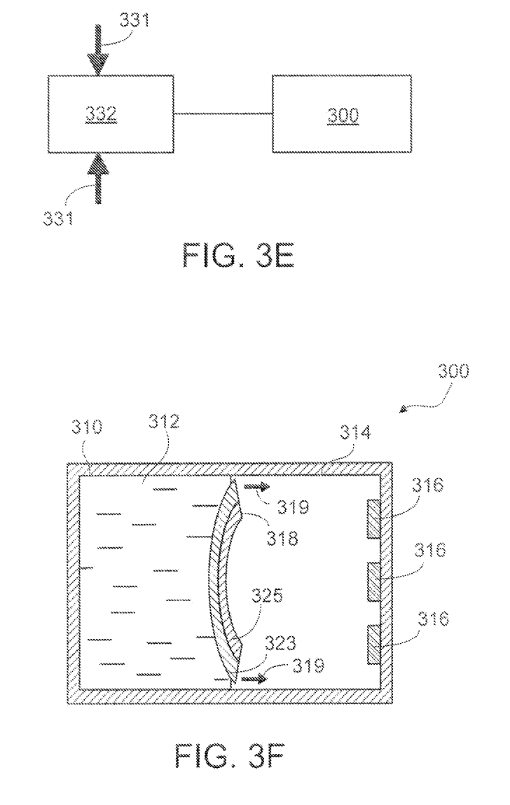

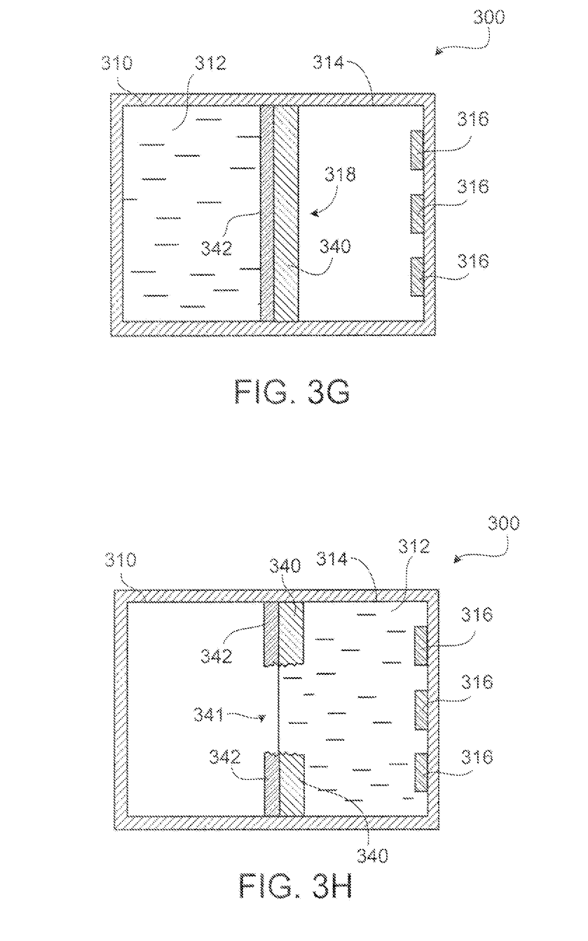

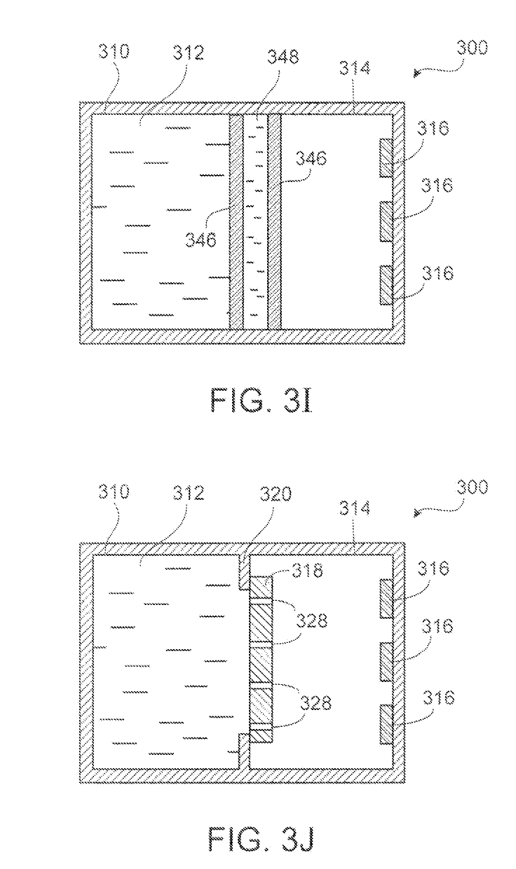

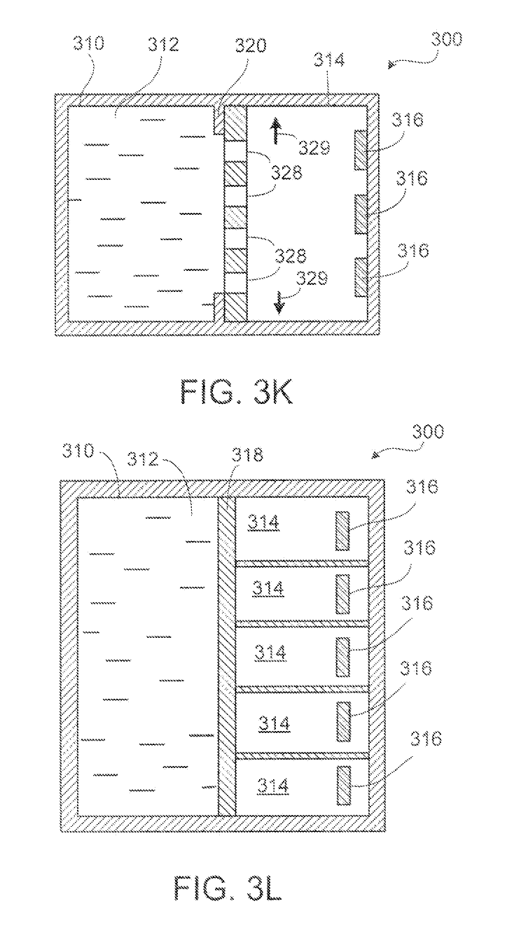

An example cross-section of a reserve battery 300 that uses a shape-memory material as an adjustable barrier is illustrated in FIG. 3A. The barrier 318 is formed using a shape-memory material at the interface between a first region 310 and a second region 314. A microheater 322 is provided on the surface on the barrier 318. As illustrated in FIG. 3B, the barrier 318 changes shape, upon activation of the microheater 322, such that electrolyte 312 flows from the first region 310, in the direction of arrows 319, to the second region 314 and reacts with electrodes 316.

Alternatively, a rise or fall in ambient temperature can be used to change the barrier 318 shape. Thus, the reserve battery may have the additional functionality of being activated as a result of ambient conditions.

Examples of shape-memory materials that can be used for barrier 318 include alloys such as nickel-titanium (Nitinol), copper-zinc-aluminum, copper-aluminum-nickel, cobalt-nickel-aluminum, cobalt-nickel-gallium, nickel-iron-gallium, and iron-manganese-silicon or polymers such as poly(ε-caprolactone) dimethacrylate and n-butyl acrylate. Other shape memory alloys and polymers may be used as well.

In some implementations, the adjustable barrier is formed using electro-active (EA) materials. Similar to shape-memory materials, EA materials also can change shape. However, instead of heat, EA materials respond to the application of an electric potential. In general, EA materials may be divided into two classes: dielectric and ionic. Dielectric EA materials change shape as a result of electrostatic forces generated by the potential applied across the material. In contrast, ionic EA materials change shape as a result of displacement of ions inside the material in response to the applied potential. An example cross-section of a reserve battery 300 that uses an electro-active material as the barrier 318 is shown in FIG. 3C. In the example of FIG. 3C, an electric potential is applied across barrier 318 by connecting the barrier 318 to a voltage source 321. In response to the applied electric potential, the barrier 318 changes shape and allows the electrolyte solution 312 to flow from the first region 310, in the direction of arrows 319, to the second region 314 to react with electrodes 316.

Voltage and current activation signals for triggering the barrier response can be controlled and generated by circuitry internal or external to the battery structure. If it is external, the circuitry can be, for example, part of the device that is powered by the battery. If the circuitry is internal, then the logic to control the voltage can be contained within the reserve battery fixture. In some implementations, the voltage also can be supplied by an external primary non-reserve battery in a multiple battery configuration. In some implementations, a radio frequency (RF) signal can be used as an activation signal. As an example, FIG. 3D shows an antenna 330 connected to the device 300 receives an RF signal 329 from an external source and converts it into an electric charge that serves as the voltage or current to activate the device. FIG. 3E shows another example in which the electrical activation signal is provided by a separate device 332 that includes piezoelectric material and which is coupled to the reserve battery 300. Upon applying a tensile or compressive stress 331 to the device 332 or to the piezoelectric material within the device 332, a charge is generated which can be used as the activation signal or stored by a capacitor and discharged at a later time.

In addition, magnetostrictive materials also can be used as an adjustable solid barrier 318. Magnetostrictive materials have the material response of mechanical deformation when stimulated by a magnetic field. Examples of magnetostrictive materials include the ferromagnetic shape-memory alloys iron-nickel-cobalt-titanium and nickel-manganese-gallium. The magnetic field can be provided by an inductive coil or other magnetic field sources as known in the art.

In some implementations, the adjustable solid barrier 318 is formed using a bimorph structure. Bimorph structures are composed of two materials having different thermal expansion coefficients. Upon heating a barrier formed of a bimorph structure, the shape of the barrier is deformed due to the differing thermal expansion coefficients. Bimorph structures also can include two different piezoelectric materials in which one material expands upon application of an electrical potential and the other contracts upon application of the same potential. In both instances, the deformation of the bimorph barrier can be used to allow electrolyte 312 in a first region 310 to come into contact with electrodes 316 in a second region 314. In some implementations, the barrier includes three or more materials with different thermal expansion coefficients or different piezoelectric properties.

An example cross-section of an adjustable barrier 318 formed using a bimorph structure is shown in FIG. 3F. The example barrier 318 shown in FIG. 3F includes two materials 323, 325 having different thermal expansion coefficients. Upon heating the barrier 318, the material 323 with the higher thermal expansion coefficient expands to a greater size than the material 325 with the lower expansion coefficient. The difference in expansion sizes leads to a tension at the interface between the materials 323, 325 which causes the barrier 318 to bend or deflect. The electrolyte solution 312 in the first region 310 then can flow (see arrows 319) into the second region 314 through openings created by the deflection of the barrier 318.

As with shape-memory materials, bimorph barriers also can be deformed upon activation of a microheater in response to ambient temperature changes. In addition, bimorph barriers can deform as a result of dielectric loss heating. In dielectric loss heating, the barrier absorbs electromagnetic signals emitted from a source such as an RF coil. Due to the absorption of the RF energy, the barrier material increases in temperature such that it changes shape.

In some implementations, the difference in expansion coefficients of the materials used in the barrier 318 may cause the barrier to break or rupture, thus allowing fluid to pass from the first to second region of the reserve battery 300. As an example, the barrier 318 shown in FIG. 3G includes a glass layer 340 upon which a metal film 342 has been deposited. In this example, the metal film 342 has a higher thermal expansion coefficient than the glass layer 340. Accordingly, when the metal is heated, it expands more than the glass layer 340 such that the glass layer is under stress as indicated by the stress arrows 344. When the stress exceeds the tensile strength of the glass, the glass layer 340 breaks so that an opening 341 is created in the barrier 318 as shown in the example of FIG. 3H. The composition of the barrier 318 is not limited to glass and metal. Instead, any number of materials or layers having different expansion coefficients such as silicon dioxide, silicon and polymers may be used to form the barrier 318.

In another example, the barrier 318 includes two layers 346 of solid material separated by a layer of liquid 348 such as water (see FIG. 3I). When the water freezes, it expands such that the solid layers experience a stress. If the expansion of the water is sufficient, the stress experienced by the solid layers 346 causes the layers 346 to rupture. If the reserve battery 300 includes an electrolyte solution that has a freezing temperature lower than water, the electrolyte solution then can pass from the first to second region. In this manner, the reserve battery 300 can be activated by a decrease in temperature rather than an increase in temperature.

In some implementations, the adjustable barrier 318 includes a layer of stretchable material that has a series of openings extending through the barrier 318 from the first region 310 to the second region 314. An example of a reserve battery 300 with a stretchable barrier 318 having openings 328 is illustrated in FIGS. 3J-3K. When the barrier 318 is in a non-stretched state and sealed against the substrate 320, the average size of an opening 328 is small enough that the electrolyte solution 312 in the first region 310 cannot pass through the barrier 318 into the second region 314 due to, for example, surface tension forces (see FIG. 3J). Upon stretching the barrier 318 (see arrows 329 in FIG. 3K), however, the openings 328 increase in size such that the electrolyte solution 312 flows through the barrier 318 and into the second region 314. Stretching of the barrier can occur in response to applying a compression or tension force on the battery 300. The stretchable barrier 318 can be formed using materials such as rubber, plastics and silicones. Other materials having elastic properties may also be used. The size of the openings 328 that allows the electrolyte solution 312 to pass through depends on the solution used and the surface properties of the stretchable material.

Alternatively, in some implementations, the stretchable barrier includes a material, such as polyurethane shape memory polymer, for example, that contracts or expands in response to a change in temperature. As with the shape-memory material and bimorph material, temperature changes in the stretchable barrier can be produced by a microheater, through dielectric loss heating or as a result of ambient temperature changes.

An advantage of using adjustable barriers that can return to their original state after activation, such as those described above, is that, in some implementations, the reserve battery may be re-used. Once the battery is activated and the electrolyte is depleted, the battery can be re-supplied with new electrodes and fresh electrolyte solution. If the device is modular, then it is possible to replace the used electrode part with a new one. The electrolyte may be manually dispensed into the electrolyte reservoir. Since the adjustable barrier can return to its original condition (i.e., separating the first region from the second region), the new electrolyte solution can be isolated and prevented from reacting with the new electrodes.

In addition, the barriers can be adjusted to an open position for short periods of time such that only a portion of the electrolyte solution passes from the first region to the second region. Accordingly, the amount of electrolyte solution used for a desired application may be limited to the amount necessary to provide power for a specified period of time while the remaining solution is conserved for later use.

In some implementations, the reserve battery 300 may include an array of second regions 314 in which each second region 314 is separated from the first region 310 by one or more barriers 318 as shown in the example of FIG. 3L. Alternatively, the battery 300 may include an array of electrochemical cells in which each cell includes a first region 310 separated from a second region 314 by a barrier 318. The barriers separating the multiple second regions can be configured to be modified individually or simultaneously depending on the device arrangement. In this way, multiple cells can be activated at different times. As an example, one or more of the cells can be activated to provide a voltage or current prior to deployment of the battery. Once the battery is in use, those voltage or current signals can provide power for signals which activate the remaining non-activated cells.

In other embodiments, the barrier is formed using materials that do not return to their original state after activation of the battery. In some implementations, a thin solid film can be used that dissipates in response to an activation signal or change in ambient conditions. For example, a barrier formed of a thin film metal or polymer may be selectively removed when exposed to an electrolyte environment by applying a controlled electrochemical potential across the barrier which leads to its dissolution. Examples of such thin metal films include gold, copper and zinc which dissolve in the presence of electrolyte solutions containing chlorine ions and an applied electrochemical potential.

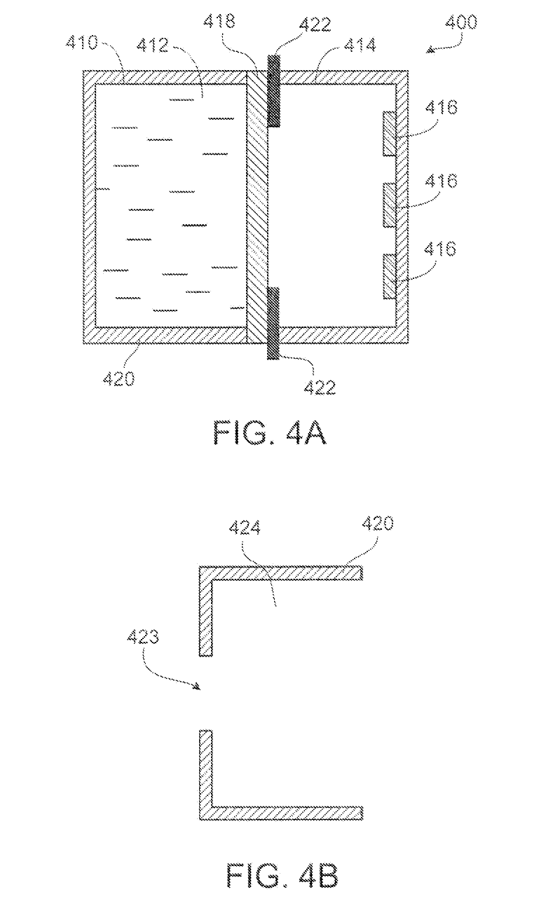

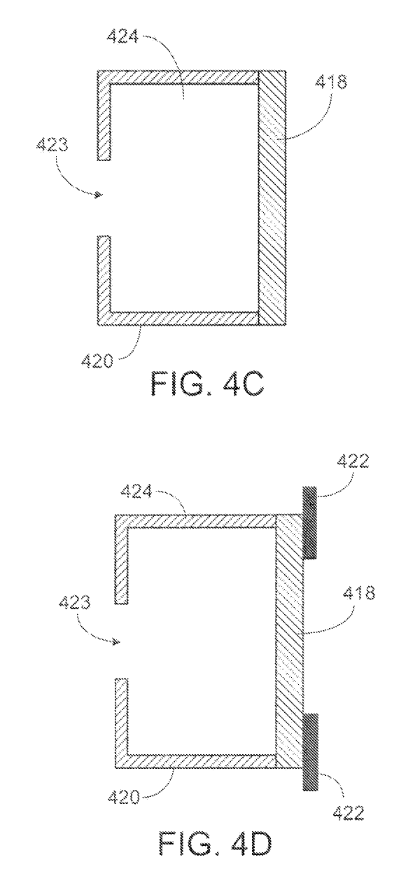

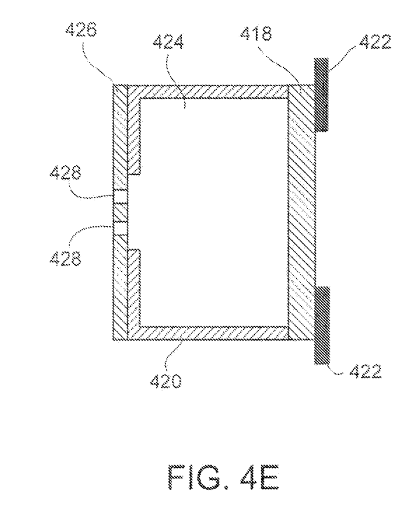

FIG. 4A illustrates an example of a reserve battery 400 having a dissolvable thin Au film as a barrier 418 that separates an electrolyte solution 412 in a first region 410 from a second region 414 that includes electrodes 416. Conductive traces 422 are formed that extend through substrate 420 and electrically connect to the barrier 418. Upon applying a voltage to the traces 422, the barrier dissolves in the presence of electrolyte solution 412, allowing the solution to flow from the first region 410 to the second region 414.

An example of a technique to fabricate the structure illustrated in FIG. 4A is shown in FIGS. 4B-4E. Reservoirs 424 for containing the electrolyte solution 412 are created in a substrate 420 (see FIG. 4B). The substrate 420 may be, for example, a semiconductor wafer, a molded polymer or plastic sheet, or a metal foil. Other substrates may be used as well. The reservoirs 424 can be formed using standard semiconductor device fabrication techniques, which include, for example, applying a mask to the surface of the substrate, patterning the mask, and etching the mask pattern into the substrate and removing the mask. Alternatively, the reservoirs 424 can be formed using stamping or molding techniques. To fill the reservoir 424 with the electrolyte solution 412, an opening 423 can be formed in the backside of the substrate 420.

As shown in FIG. 4C, the reservoirs 424 are capped by laminating the reservoir opening with a thin Au foil or a layer of vapor deposited Au. Vapor deposition methods can include, but are not limited to, standard sputtering and evaporation techniques. Alternatively, the cap may be fabricated by filling the reservoir 424 with wax and then covering the wax-filled reservoir with Au using vapor deposition methods or laminating a gold film. The wax is then melted and drips out of the reservoir 424, leaving reservoirs capped with a Au barrier layer 418. Conductive traces 422 are then formed on the surface of the barrier 418 (see FIG. 4D). The traces 422 may be used as activation terminals for applying a voltage and dissolving the barrier.

Each reservoir 424 then is filled with the electrolyte solution 412 through opening 423 and enclosed with a cover sheet 426 to prevent the electrolyte from escaping. Alternatively, each reservoir 424 can be filled after the cover sheet 426 is applied by supplying the electrolyte solution 412 into openings 428 in the cover 426 (see FIG. 4E). The openings 428 can include one-way valves that allow fluid to be injected into the reservoir 424 but not exit, such as, for example, ink-jet printers. In another example, the openings 428 are coated with a non-wettable layer that prevents fluid from leaking out the openings 428 after the fluid is injected into the reservoir 424. In some implementations, the electrolyte solution 412 is injected through a cover sheet 426 that does not include openings but is re-sealable and pierceable with, for example, a syringe or a micro pipette dispenser such as those typically used in the pharmaceutical industry.

In some implementations, the barrier includes materials that dissipate without the aid of an electrochemical reaction between the barrier and electrolyte. For example, the barrier may be formed from a low melting temperature metal or alloys, for example, tin-lead solder or Wood's alloy. When voltage is applied to traces 422, current passes through the metal and melts the metal as a result of resistive heating effects. Upon melting, the electrolyte solution 412 flows from the first region 410 into the second region 414. Alternatively, the barrier can be formed on a resistive heating element. Activating the heating element melts the barrier, allowing the electrolyte solution to flow from the first region to the second region. In the context of this disclosure, low melting temperature generally refers to temperatures below 250° C. Examples of low melting temperature barriers may include materials such as wax, polymers, solder and other fusible alloys.

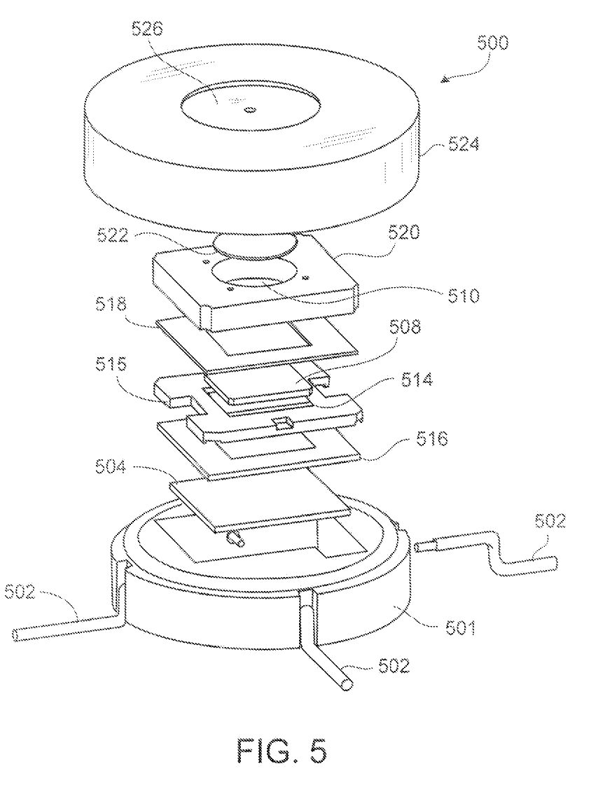

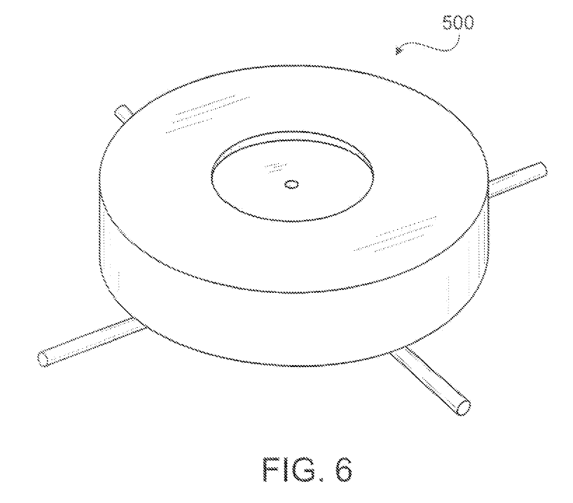

An exploded view of an example reserve battery package 500 having an adjustable barrier is shown in FIG. 5. The package includes a base 501 for holding external terminals 502. The external terminals 502 are electrically connected to electrode 516 inside of the package base 501. The electrode 516 can be formed as a series of interdigited electrodes having alternating polarity. Other electrode designs may be used as well. A compliant sheet 504 can be provided beneath the electrode 516 to absorb shock and excessive force on the package 500. A spacer 515 between the electrode 516 and adjustable barrier 518 has an opening 514 in which a filter paper stack 508 can be placed. The filter paper stack 508 allows the electrolyte solution to spread evenly across the electrode 516. A reservoir 520 having an opening 510 is positioned above the adjustable barrier 518 and is used to hold the electrolyte solution prior to activation of the reserve battery. A second filter paper stack 522 can be placed in the opening 510 to facilitate even distribution of the electrolyte on the adjustable barrier 518. A metal cap 524 is secured to the package base 501 to confine the reserve battery components and seal the electrolyte solution in the reservoir 520. The cap 524 can include a window 526 that allows a user to observe the operation of the battery. For example, upon reacting with the electrode 516, the electrolyte solution may change color, which can be viewed through the window 526. FIG. 6 illustrates an example of the reserve battery package 500 fully assembled.

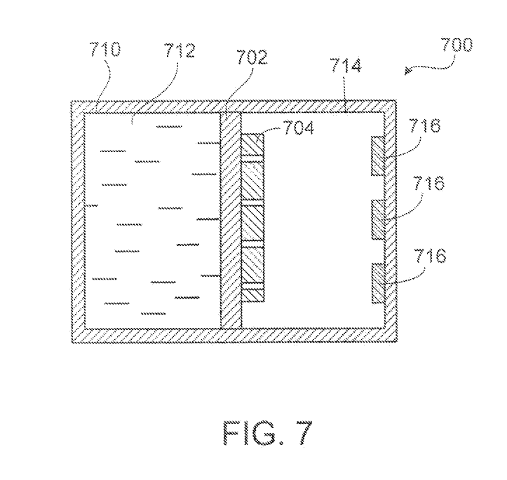

More than one type of adjustable barriers also may be used to control the flow of fluid from a first region to a second region. For example, FIG. 7 shows a reserve battery 700 that includes two different types of adjustable barriers. A first adjustable barrier 702 separates a first region 710 from a second region 714 and is formed from a solid non-permeable material such as the dissolvable metal film shown in FIG. 4A. A second adjustable barrier 704 positioned adjacent to the first barrier 702 includes a porous or semi-permeable material such as the stretchable barrier shown in FIGS. 3J-3K. Other different adjustable barriers may be used as the first and second barrier as well. In some implementations, the first barrier 702 can be used to facilitate long term storage of the battery 700 in which electrolyte vapors are prevented from permeating into the second region 714 over time. In addition, the first barrier 702 can be selected to withstand rough handling and extreme environmental conditions. When the reserve battery 700 is ready to be deployed, however, and the ambient conditions are less severe, the first barrier 702 can be removed to allow the second barrier 704 to function as the main barrier between an electrolyte solution 712 and electrodes 716. The second barrier 704 then can be used to allow controlled release of the electrolyte solution 712 into the second region 714. In some implementations, the first barrier 702 may be actuated or removed when sufficient energy and resources are available for activation of the reserve battery 700 whereas the second barrier 704 may be used when less energy is available for activation of the reserve battery 700.

A number of embodiments of the invention have been described. Nevertheless, it will be understood that various modifications may be made without departing from the spirit and scope of the invention. Other embodiments are within the scope of the claims.

What is claimed is:

1. An electrochemical cell comprising:
a first cell;
a second cell; and
an adjustable barrier, wherein, in a first state, the barrier isolates a fluid in the first cell from the second cell and
wherein the barrier is operable, in response to an activation signal, to change to a second state to allow the fluid to pass into the second cell and activate the electrochemical cell.

2. The device according to claim 1 wherein the fluid comprises a solvent solution mixed with a salt and the second cell comprises one or more electrodes.

3. The device according to claim 1 wherein the fluid comprises an electrolyte solution and the second cell comprises one or more electrodes.

4. The device according to claim 3 wherein the electrolyte solution comprises ions to transport charge between a first electrode and a counter-electrode.

5. The device according to claim 3 wherein activation of the electrochemical cell comprises an electrochemical reaction between the electrolyte solution and the one or more electrodes to produce an electric potential.

6. The device according to claim 3 wherein activation of the electrochemical cell comprises ion transportation between the electrolyte solution and the one or more electrodes to produce an electric potential.

7. The device according to claim 1 wherein the activation signal comprises an applied electrical current.

8. The device according to claim 1 wherein the activation signal comprises an applied electric field, magnetic field or electromagnetic field.

9. The device according to claim 1 wherein the activation signal comprises an applied change in temperature.

10. The device according to claim 1 wherein the barrier comprises a rotatable member.

11. The device according to claim 1 wherein the barrier comprises:
a first member;
a second member overlapping the first member; and
a through-hole in the first member misaligned with a through-hole in the second member, wherein the first member is operable to move, in response to the activation signal, such that a portion of the through-hole in the first member aligns with a portion of the through-hole in the second member.

12. The device according to claim 11 wherein each of the first and second members comprises a non-wettable layer.

13. The device according to claim 1 wherein the barrier comprises a material that deforms in response to a change in temperature.

14. The device according to claim 13 wherein the barrier comprises nitinol.

15. The device according to claim 1 wherein the barrier comprises a material that deforms in response to an applied electric potential.

16. The device according to claim 15 wherein the material is piezoelectric.

17. The device according to claim 1 wherein the barrier comprises a material that deforms in response to an applied magnetic field.

18. The device according to claim 1 wherein the barrier comprises at least two materials having different thermal expansion coefficients.

19. The device according to claim 1 wherein the barrier comprises at least two piezoelectric materials with alternate polarities.

20. The device according to claim 1 wherein the barrier comprises a material that dissolves under an applied electrical potential when in contact with the fluid in the first cell.

21. The device according to claim 20 wherein the barrier comprises gold, copper or zinc.

22. The device according to claim 20 wherein the fluid is an electrolyte solution comprising chlorine ions.

23. The device according to claim 1 wherein the barrier comprises a heater and a layer of material on the heater, wherein the layer of material is adapted to melt upon activation of the heater.

24. The device according to claim 23 wherein the layer of material comprises a polymer.

25. The device according to claim 23 wherein the layer of material comprises wax.

26. The device according to claim 1 wherein the barrier comprises:
a first member; and
a second member disposed on the first member, wherein the second member is configured to break in response to expansion or contraction of the first member such that an opening forms in the barrier.

27. The device according to claim 1 wherein the barrier comprises:
a first member;
a second member; and
a fluid disposed between the first and second members, wherein the first and second members are configured to break in response to expansion or contraction of the fluid such that an opening forms in the barrier.

28. The device according to claim 1 wherein the barrier comprises a flexible member.

29. The device according to claim 1 wherein the barrier comprises a non-wetting surface.

30. The device according to claim 1 wherein the barrier comprises a stretchable member having one or more openings extending from the first cell to the second cell,
wherein, in the first state, a size of the opening is operable to prevent the fluid from passing into the second cell and wherein, in the second state, the barrier is stretched such that the size of the opening is operable to allow the fluid to pass into the second cell.

31. The device according to claim 1 further comprising:
a plurality of second cells, wherein, in a first state, the barrier isolates the fluid in the first cell from the plurality of second cells and
wherein the barrier is operable, in response to an activation signal, to change to a second state to allow the fluid to pass into and activate one or more of the plurality of second cells.

32. An electrochemical cell comprising:
a first cell;
a second cell;
a first adjustable barrier; and
a second adjustable barrier,
wherein the first barrier, in a first state, and the second barrier, in a first state, isolate a fluid in the first cell from the second cell,
wherein the first barrier is operable, in response to a first activation signal, to change to a second state to allow the fluid to pass to the second barrier and
wherein the second barrier is operable, in response to a second activation signal, to change to a second state to allow the fluid to pass into the second cell and activate the electrochemical cell.

33. A battery comprising:
a first compartment containing an electrolyte solution;
a second compartment containing electrodes;
an adjustable barrier which, in a first state, isolates the electrolyte solution in the first compartment from the second compartment; and
a lead connected to the adjustable barrier wherein, in response to an electrical signal applied to the lead, the barrier is operable to allow the electrolyte solution to enter into the second compartment such that an electro-chemical reaction between the electrolyte solution and the electrodes generates an electrical potential difference across the electrodes.

34. The battery according to claim 33 comprising a cover on the first compartment wherein the cover includes openings coated with a non-wetting layer.

35. The battery according to claim 33 comprising a cover on the first compartment wherein the cover includes a one-way fluid valve.

36. The battery according to claim 33 comprising a re-sealable and pierceable cover.

37. A method of activating an electrochemical cell having a first cell and a second cell comprising:
rotating a barrier about an axis to a first position to block flow of a fluid from the first cell to the second cell and
rotating the barrier to a second position to allow the fluid to flow from the first cell to the second cell to interact with an element in the second cell to activate the electrochemical cell.

38. The method according to claim 37 wherein activation of the electrochemical cell comprises producing an electric potential.

39. A method of activating an electrochemical cell having a first cell and a second cell comprising:
providing a first member having a through-hole that, in a first position, overlaps a second member having a through-hole such that the through-holes are misaligned and the first and second member block the flow of a fluid from the first cell to the second cell and
adjusting each of the first and second member to a second position wherein a portion of the through-hole in the first member is at least partially aligned with a portion of the through-hole in the second member such that fluid flows from the first cell through the at least partially aligned through-holes into the second cell and interacts with an element in the second cell to activate the electrochemical cell.

40. The method according to claim 39 wherein activation of the electrochemical cell comprises producing an electric potential.

41. A method of activating an electrochemical cell having a first cell and a second cell comprising:
providing a barrier, in a first position, to prevent the flow of fluid from the first cell to the second cell; and
deforming the barrier to allow the fluid to flow from the first cell to the second cell to interact with an element in the second cell and activate the electrochemical cell.

42. The method according to claim 41 wherein activation of the electrochemical cell comprises producing an electric potential.

43. A method according to claim 41 wherein the deformation of the barrier occurs in response to a change in temperature of the barrier.

44. A method according to claim 41 wherein the deformation of the barrier occurs in response to an electric current supplied through the barrier.

45. A method according to claim 41 wherein the deformation of the barrier occurs in response to an electric or magnetic field applied to the barrier.

46. A method according to claim 41 wherein deforming the barrier comprises expanding or contracting the barrier.

47. A method of activating an electrochemical cell having a first cell and a second cell comprising:
providing a barrier, which, in a first position, is in contact with the fluid and prevents the flow of fluid from the first cell to the second cell; and
removing the barrier to allow the fluid to flow from the first cell to the second cell to activate the electrochemical cell, wherein removal of the barrier comprises applying an electric potential to the barrier or an electric current through the barrier.

48. The method according to claim 47 wherein removing the barrier comprises dissolving the barrier in an electrochemical reaction.

49. The method according to claim 47 wherein removing the barrier comprises melting the barrier.

50. The method according to claim 47 wherein activation of the electrochemical cell comprises producing an electric potential.

51. A method of activating an electrochemical cell having a first cell and a second cell comprising:
providing a barrier, which, in a first position, prevents the flow of fluid from the first cell to the second cell, wherein the barrier comprises a first member disposed on a second member; and
expanding or contracting the first member to break the second member such that an opening forms in the barrier that allows the fluid to flow from the first cell to the second cell and activate the electrochemical cell.

52. The method according to claim 51 wherein activation of the electrochemical cell comprises producing an electric potential.

53. A method of activating an electrochemical cell having a first cell and a second cell comprising:
providing a barrier, which, in a first position, prevents the flow of fluid from the first cell to the second cell, wherein the barrier comprises a fluid disposed between a first member and a second member; and
expanding or contracting the fluid to break the first and second members such that an opening forms in the barrier that allows the fluid to flow from the first cell to the second cell and activate the electrochemical cell.

54. The method according to claim 53 wherein activation of the electrochemical cell comprises producing an electric potential.

55. A method of activating an electrochemical cell having a first cell and a second cell comprising:
providing a first barrier and a second barrier which, in a first position, prevent the flow of fluid from the first cell to the second cell;
adjusting the first barrier to a second position to allow the fluid to pass to the second barrier; and
adjusting the second barrier to a second position to allow the fluid to pass to the second cell and activate the electrochemical cell.

56. The method according to claim 55 wherein activation of the electrochemical cell comprises producing an electric potential.
